(19) United States
(12) Patent Application Publication
(10) Pub. No.: US 2010/0198903 A1
(43) Pub. Date: Aug. 5, 2010

(54) NETWORK-SUPPORTED EXPERIMENT DATA COLLECTION IN AN INSTRUCTIONAL SETTING

(76) Inventors: Corey E. Brady, Weston, FL (US); Sunil Gupta, Weston, FL (US); Tanner Robert Andrews, DeLand, FL (US); David Michael Cole, Pembroke Pines, FL (US); Sekar Udayamurthy, Mylapore (IN)

Correspondence Address: TEXAS INSTRUMENTS INCORPORATED, P O BOX 655474, M/S 3999, DALLAS, TX, 75265, US

(21) Appl. No.: 12/363,728

(22) Filed: Jan. 31, 2009

(51) Int. Cl. G06F 15/16

(52) U.S. Cl. 709/201; 709/218

(57) ABSTRACT

Methods and systems are provided for network-supported remote data collection in an instructional setting in which experiment data from data sources used in laboratory demonstrations is made available for student collection and analysis by way of a network of calculators.

### BACKGROUND OF THE INVENTION

The nature, rationale, and use of laboratory demonstrations and experiments constitute a critical set of issues in science classrooms. The widespread adoption of low-cost probes, i.e., computerized measuring devices, has increased the use of student-run laboratory experiments in middle and high school science classrooms. However, there are many occasions when demonstrations continue to be used, for reasons stemming from feasibility, logistics, and/or cost. For example, demonstrations are used when experiments are particularly dangerous, when they are difficult to set up, control, or manage, when they extend over a long period of time, when there is limited availability of equipment, and/or when multiple student set-ups would occupy too much limited classroom space

The power of student-centered, active learning is widely acknowledged, however, and many science teachers express concern that demonstrations are still used in some instances, whether for the reasons above or to save time. Thus, it would be useful to allow greater involvement by students in experiments that are run as demonstrations.

### SUMMARY OF THE INVENTION

Embodiments of the invention provide methods and systems for network-supported remote data collection in an instructional setting in which laboratory demonstrations can be “opened up” for student collection and analysis of experimental data by way of a network of calculators. More specifically, embodiments of the invention provide a method for experiment data collection in an instructional setting, the method including receiving over a network in the instructional setting experiment data from a data source generating the experiment data, and providing over the network a first portion of the received experiment data to a first calculator.

Embodiments of the invention also provide a classroom instruction system that includes a computer system comprising instructional software, a data source communicatively coupled to the computer system via a network, and a plurality of calculators communicatively coupled to the computer system via the network, wherein the data source is configured to transmit experiment data over the network, the instructional software is configured to receive the experiment data and to provide portions of the experiment data to the plurality of calculators over the network, and the plurality of calculators are configured to subscribe to the received experiment data and to download at least one of the portions of the experiment data.

Embodiments of the invention further provide a method of instruction of students in an instructional setting, the method including communicatively coupling a data source configured to generate experiment data to a computer system, communicatively coupling a plurality of calculators to the computer system, conducting an experiment using the data source, wherein experiment data is transmitted to the computer system from the data source, receiving the experiment data by the computer system, and sending portions of the experiment data to the plurality of calculators responsive to requests from the plurality of calculators, wherein students use the calculators to analyze the portions of the experiment data to generate analysis results.

### BRIEF DESCRIPTION OF THE DRAWINGS

Particular embodiments in accordance with the invention will now be described, by way of example only, and with reference to the accompanying drawings:

FIG. 1 is a system diagram in accordance with one or more embodiments of the invention;

FIG. 2 shows an example of a handheld computing device in accordance with one or more embodiments of the invention;

FIG. 3A is a block diagram of a handheld computing device in accordance with one or more embodiments of the invention;

FIG. 3B is a block diagram of a computer system in accordance with one or more embodiments of the invention;

FIG. 4 is a flow diagram of a method for student data collection and analysis in accordance with one or more embodiments of the invention.

### DETAILED DESCRIPTION OF EMBODIMENTS OF THE INVENTION

Specific embodiments of the invention will now be described in detail with reference to the accompanying figures. Like elements in the various figures are denoted by like reference numerals for consistency.

Certain terms are used throughout the following description and the claims to refer to particular system components. As one skilled in the art will appreciate, components of computer systems may be referred to by different names and/or may be combined in ways not shown herein without departing from the described functionality. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” and derivatives thereof are intended to mean an indirect, direct, optical, and/or wireless electrical connection. Thus, if a first device couples to a second device, that connection may be through a direct electrical connection, through an indirect electrical connection via other devices and connections, through an optical electrical connection, and/or through a wireless electrical connection.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description. In addition, although method steps may be presented and described herein in a sequential fashion, one or more of the steps shown and described may be omitted, repeated, performed concurrently, and/or performed in a different order than the order shown in the figures and/or described herein. Accordingly, embodiments of the invention should not be considered limited to the specific ordering of steps shown in the figures and/or described herein.

Embodiments of the present invention are discussed below with respect to an embodiment in which a graphing calculator is used as an input device. It should be noted, however, that embodiments of the present invention may be useful for other types of electronic devices, particularly handheld computing devices. Examples of other types of handheld computing devices in which embodiments of the present invention may be useful include scientific calculators, advanced calculators able to upload and run software applications, handheld-sized limited-purpose computer devices, handheld-sized educational computer devices, handheld-sized portable computer devices, portable computer devices, personal digital assistants (PDA), palmtop computers, personal communicators, personal intelligent communicators, cellular or mobile telephones, global positioning system (GPS) devices, portable inventory logging computer devices (as may be used by courier deliverers, for example), handheld monitoring devices (as may be used by meter readers, for example), handheld parking ticket administering devices, handheld portable email devices, handheld portable Internet browsing devices, handheld portable gaming devices, and any combination thereof.

Embodiments of the present invention provide systems and methods for student collection and analysis of experimental data using handheld devices coupled to a network in an instructional setting such as a classroom or laboratory. More specifically, in one or more embodiments of the invention, a teacher may set up an experiment in the classroom in which a data source coupled to the network collects experiment data and transfers that experiment data to a classroom computer system operated by the teacher. The teacher may also configure instructional software on the classroom computer system to allow students to download experiment data to handheld devices from the classroom computer system via the network for local analysis. The teacher may further configure the instructional software to collect the student analyses from the handheld devices for further instructional purposes.

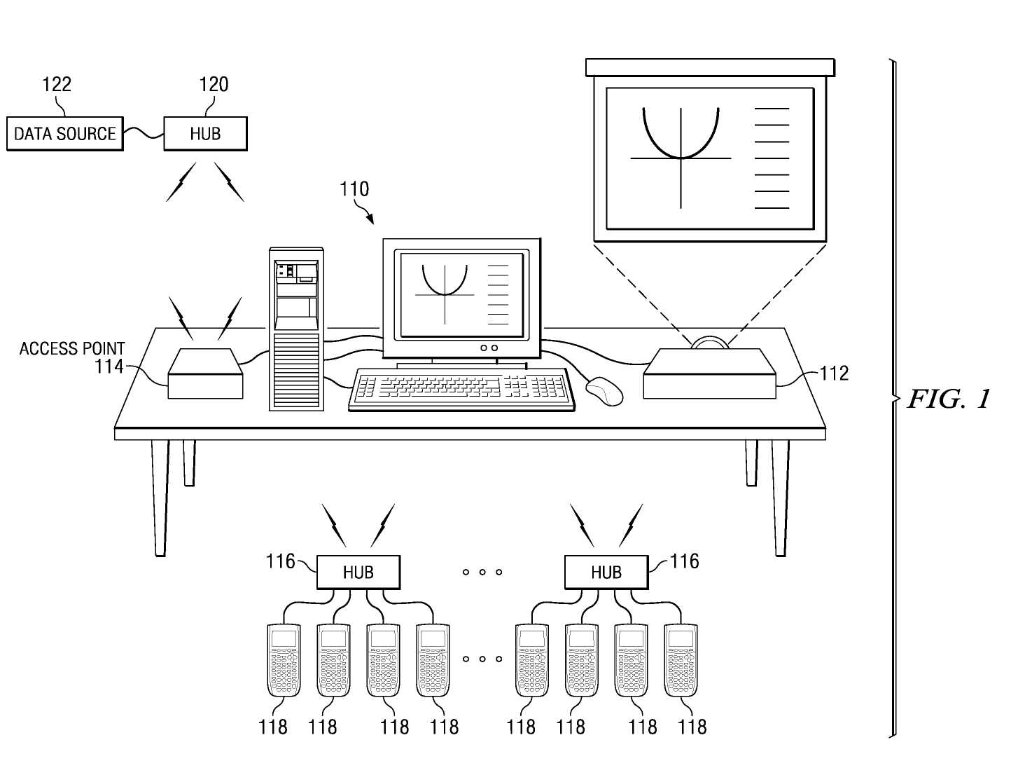

FIG. 1 shows a diagram of a classroom instruction system in accordance with one or more embodiments of the invention. The classroom instruction system includes a computer system 110 communicatively coupled to a projector 112, which may project the display of the computer system 110 onto a wall, screen, or other surface. The computer system 110 may include, for example, instructional software (not shown) explained in more detail below. The computer system 110 may be any general purpose computing device, such as a personal computer, a mini-computer, a main frame, a personal data assistant, a laptop computer, or the like.

The computer system 110 is also communicatively coupled to an access point 114. The access point 114 provides an interface for the computer system 110 to communicate with one or more hubs 116 and one or more hubs 120. In one or more embodiments of the invention, the access point 114 provides a wireless interface, such as 802.1 1b, 802.11g, or the like, to the hubs 116 and 120. The communications link between the access point 114 and the hubs 116 and/or 120, however, may be a wired communications link.

Each of the hubs 116 is communicatively coupled to one or more handheld computing devices 118. The handheld computing device 118 may be any electronic computing device, such as a calculator, personal data assistant, tablet PC, or the like. For example, in one or more embodiments of the invention, the handheld computing device 118 is a graphing calculator such as the TI-84 Plus graphing calculator manufactured by Texas Instruments, Inc., of Dallas, Tex. In some embodiments of the invention, the handheld computing device 110 is an electronic device operating an emulation of another electronic device. For example, the handheld computing device 118 may be a PDA configured to perform an emulation of the TI-84 Plus graphing calculator.

The communications links between the handheld computing devices 110 and the hubs 116 and between the computer system 110 and the access point 114 are illustrated as a wired interface for illustrative purposes only. In an embodiment, the wired interfaces comprise a USB communications link. These wired communications links, however, may comprise either a wired or wireless communications link. Once connected, bidirectional communications may be performed between the handheld computing devices 118 and the computer system 110 and/or other handheld computing devices 118 via the hubs 116 and the access point 114.

The hub 120 is communicatively coupled to a data source 122. The data source 122 is configured to provide experiment data electronically. In one or more embodiments, the data source 122 includes a sensor and circuitry to receive experiment data from the sensor and provide the experiment data to the hub 120. The sensor may be any sensor suitable for classroom use including, but not limited to, a temperature sensor, a force sensor, a sound sensor, a humidity sensor, a light sensor, a motion sensor, a voltage sensor, a conductivity sensor, a flow rate sensor, a soil moisture sensor, a gas pressure sensor, a magnetic field sensor, a turbidity sensor, a salinity sensor, and a pH sensor. Further, more than sensor may be included in the data source 122. Although not explicitly shown in FIG. 1, more than one data source may be connected to the hub 120 and more than one hub 120 may with connected data source(s) may be present in the classroom. Further, in one or more embodiments of the invention, the hub 120 is the same type of hub as the hubs 116.

The computer system 110, the access point 114, the hubs 116, the hub 120, and the handheld computing devices 118 are illustrated as separate components for illustrative purposes only. Two or more of these components may be integrated into a single component. For example, the access point 114 may be integrated into the computer system 110, and a wireless transceiver may be integrated into the handheld computing device 118 and/or the data source 122 to communicate directly with the access point 114 and/or the computer system system 110, thereby negating a need for separate hubs 116 and/or 120.

The instructional software on the computer system 110 includes functionality to manage experiments involving the data source 122 and to analyze data from received from the data source 122 via the hub 120 and the access point 114. The instructional software also includes functionality to provide experiment data received from the data source 122 to the handheld computing devices 118. More specifically, in one or more embodiments of the invention, the instructional software includes functionality to allow a teacher to configure the computer system 110 to allow a student using a handheld computing device 118 to subscribe to the experiment data to download some or all of the experiment data to the handheld computing device 118. In some embodiments of the invention, the instructional software further includes functionality to allow a teacher to configure the computer system 110 to allow a specific handheld computing device 118 to download experiment data for a predefined time period during which other handheld computing devices 118 are locked out. In this way, the teacher can help ensure that each handheld computing device 118 receives a unique set of experiment data. Further, the instructional software also includes functionality to receive analyses of the experiment data from the handheld computing devices 118 for use by the teacher for further instructional purposes.

In operation, a teacher sets up an experiment using the data source 122 and also configures the instructional software on the computer system 110 to receive experiment data from the data source 122. The teacher also configures the instructional software to provide the experiment data to the handheld computing devices 118 being operated by students. More specifically, the teacher configures the instructional software to allow students using the handheld devices 118 to subscribe to the experiment data for downloading. Each student may have his or her own handheld computing device 118 or groups of students may share devices. Prior to starting the experiment, the teacher may conduct a lecture and students may set up the handheld computing devices 118 to perform calculations using experiment data.

Once the teacher starts the experiment, the data source 122 begins sending experiment data to the computer system 110 via the hub 120 and the access point 114. Students then use the handheld computing devices 118 to subscribe to the experiment data to download at least a portion of the experiment data for use in the previously set up calculations. At some point, the teacher may use the instructional software to terminate the collection of experiment data. The teacher may then conduct further discussion of the experiment results with the students, and may, optionally, configure the instructional software to receive student results from the handheld computing devices 118 to be used in the discussion and/or further analysis performed on the computer system 110. The teacher may control the operation of the instructional software and the computer system 110 via an input device (e.g., a keyboard, mouse, etc.) coupled directly to the computer system 110 in order to illustrate experiment concepts and results. As the teacher controls the instructional software and the computer system 110, results, such as graphs, plots, equations, text, symbols, or the like, are enlarged and displayed on a large surface, such as a screen or wall, via the projector 112.

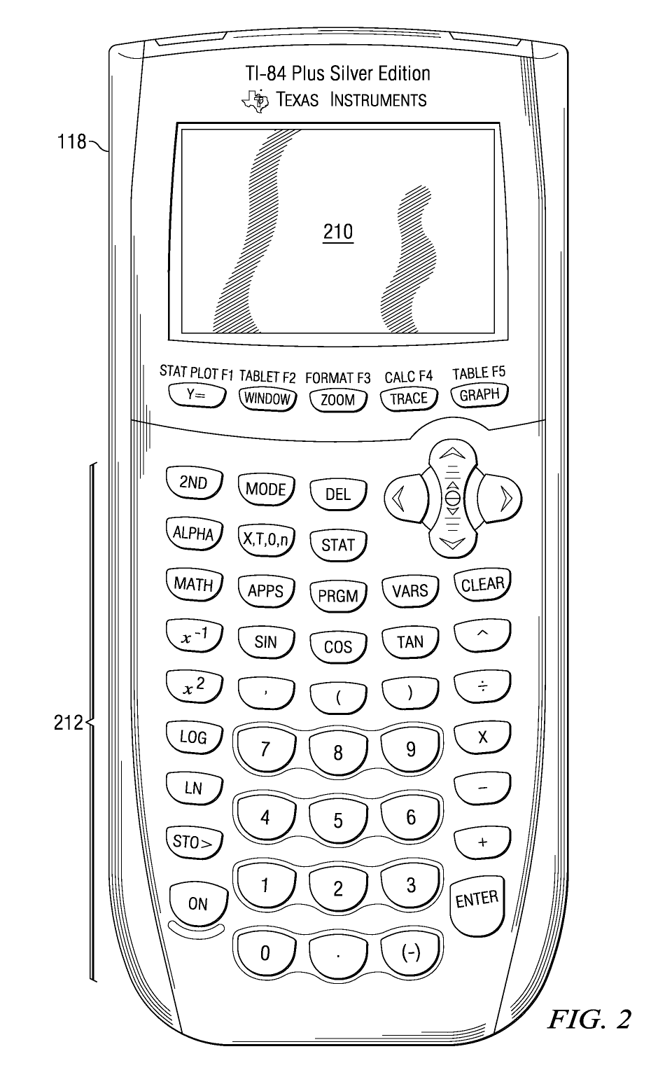

FIG. 2 shows an example of a handheld computing device 118 in accordance with one or more embodiments of the invention. For illustrative purposes only, the handheld computing device 118 illustrated in FIG. 2 is similar to a TI-84 Plus graphing calculator. The TI-84 Plus is used for illustrative purposes only and should not be construed to limit the invention as claimed. As shown in FIG. 2, the handheld computing device 118 includes a graphical display 210 and a set of keys 212. The graphical display 210 provides a means upon which graphs of various functions and/or one or more lines of text/symbols may be displayed. The graphical display 210 may be, for example, an LED display. The set of keys 212 is located below the graphical display 210 and provides a method for a user, e.g., a student, to enter data and functions.

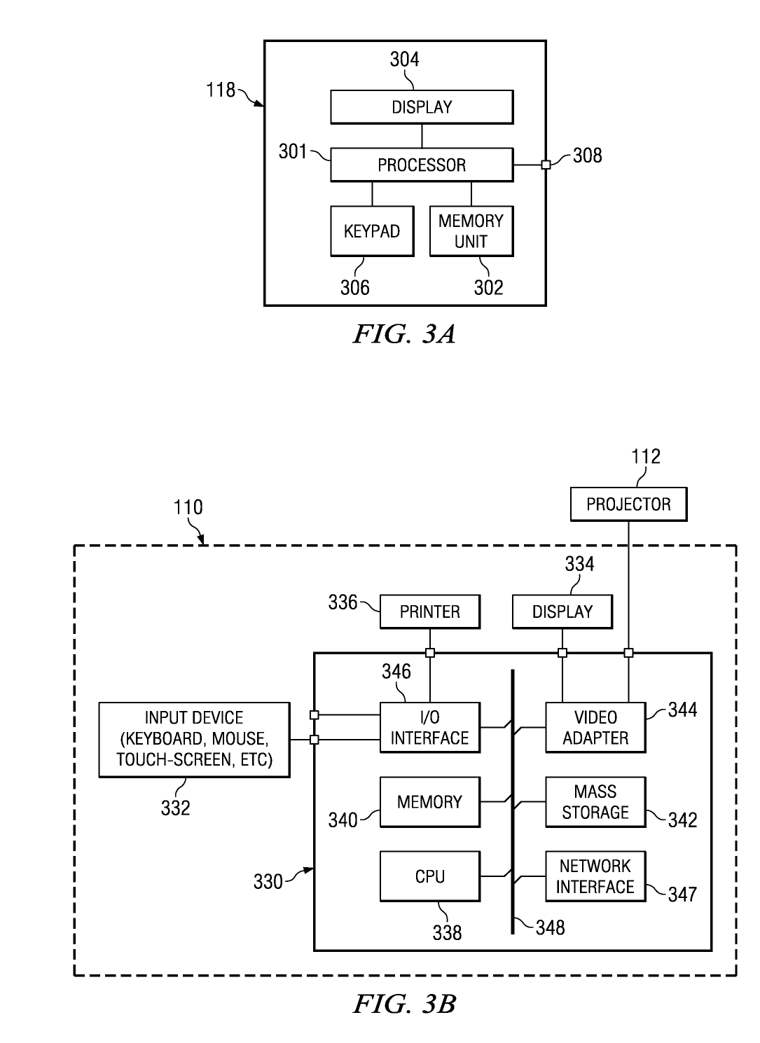

FIGS. 3A and 3B are block diagrams of the handheld computing device 118 and the computer system 110, respectively, in accordance with one or more embodiments of the invention. Generally, the handheld computing device 118 includes a processor 301 connected to a memory unit 302, which may include one or both of read-only memory (ROM) and random-access memory (RAM). In some embodiments of the invention, the ROM stores software programs and the RAM stores intermediate data and operating results.

An input/output port 308 provides connectivity to hubs 116 (as shown in FIG. 1), thereby communicatively coupling the handheld computing device 118 to the computer system 110. In one or more embodiments of the invention, the input/output port 308 comprises a bidirectional connection such as a mini-A USB port. In this manner, the handheld computing device 118 may transmit information to the computer system 110 as well as receive information from the computer system 110. Also included in the handheld computing device 118 are a display 304 and a keypad 306.

The computer system 110 includes a processing unit 330 equipped with one or more input devices 332 (e.g., a mouse, a keyboard, or the like), and one or more output devices, such as a display 334, a printer 336, or the like. The processing unit 330 may be, for example, a desktop computer, a workstation, a laptop computer, a personal digital assistant, a dedicated unit customized for a particular application, or the like.

The processing unit 330 includes a central processing unit (CPU) 338, memory 340, a mass storage device 342, a video adapter 344, and an I/O interface 346 connected to a bus 348. The bus 348 may be one or more of any type of several bus architectures including a memory bus or memory controller, a peripheral bus, video bus, or the like. The CPU 338 may be any type of electronic data processor. For example, the CPU 338 may be a Pentium™. processor from Intel Corp., an Athlon processor from Advanced Micro Devices, Inc., a Reduced Instruction Set Computer (RISC), Application-Specific Integrated Circuit (ASIC), or the like. The memory 340 may be any type of system memory such as static random access memory (SRAM), dynamic random access memory (DRAM), synchronous DRAM (SDRAM), read-only memory (ROM), a combination thereof, or the like. Further, the memory 340 may include ROM for use at boot-up, and DRAM for data storage for use while executing programs.

The mass storage device 342 (e.g., a computer readable medium) may comprise any type of storage device configured to store data, programs, and other information and to make the data, programs, and other information accessible via the bus 348. In one or more embodiments of the invention, the mass storage device 342 is configured to store the instructional program to be executed by the CPU 338. The mass storage device 342 may be, for example, one or more of a hard disk drive, a magnetic disk drive, an optical disk drive, or the like.

The video adapter 344 and the I/O interface 346 provide interfaces to couple external input and output devices to the processing unit 330. As illustrated in FIG. 3B, examples of input and output devices include the display 334 coupled to the video adapter 344 and the mouse/keyboard 332 and the printer 336 coupled to the I/O interface 346.

The processing unit 330 also includes a network interface 347. The network interface allows the processing unit 330 to communicate with remote units via a network (not shown). In one or more embodiments of the invention, the network interface 347 allows the analysis system 110 to communicate via a network to the handheld computing devices 118, e.g., calculators. The network interface 347 may provide an interface for a wired link, such as an Ethernet cable or the like, or a wireless link.

The computer system 110 may also include other components not specifically shown. For example, the computer system 110 may include power supplies, cables, a motherboard, removable storage media, cases, and the like.

One type of networking system that may be used in one or more embodiments of the invention to communicatively couple the handheld computing devices 118 to the computer system 110 is the TI-Navigator™ available from Texas Instruments, Dallas, Tex. The TI-Navigator™ includes hubs that couple to calculators and wirelessly communicate with an access point that is coupled to a personal computer system. Further, data sources that may be used in one or more embodiments of the invention include, for example, the CBR 2™ sonic motion detector available from Texas Instruments and various sensors available from Vernier Software and Technology, Beaverton, Oreg.

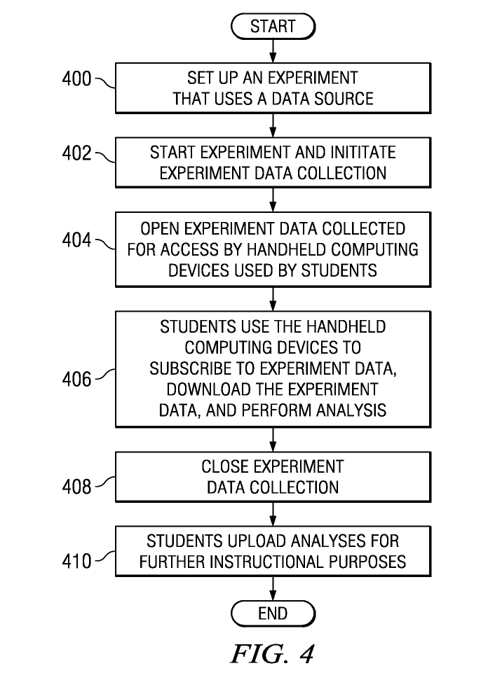

FIG. 4 is a flow diagram of a method for experiment data collection and use in a classroom in accordance with one or more embodiments of the invention. Initially, an experiment is set up in the classroom in which a data source is to be used (400). The equipment for the experiment may be set up by the teacher and/or by one or more of the students. As part of the set up, the teacher also configures a computer system wirelessly connected to the data source to collect experiment data to be provided by the data source and further configures the computer system to provide experiment data to handheld computing devices wirelessly connected to the computer system. As previously explained, the teacher may configure the computer system to only allow access by a specific handheld computing device for a predefined time period. The teacher may also configure the computer system to allow any handheld computing device to access the experiment data at any time and/or for any time period.

Once the experiment is set up, the teacher may optionally conduct a lecture prior to starting the experiment and/or allow students some time period to set up their handheld devices with computations to be used with experiment data collected from the data source. The experiment is then started and experiment data collection is initiated (402). More specifically, whatever needs to be done to start conducting the experiment and causing experiment data to be generated is performed (e.g., a temperature probe is inserted in hot liquid or an object is set in motion in front of a motion sensor). The data source then begins sending experiment data. The teacher also initiates experiment data collection on the computer system so that the experiment data sent by the data source is received by the computer system.

Once experiment data collection is initiated, the teacher then opens the collected experiment data for access by handheld computing devices operated by the students (404). Students may then use the handheld computing devices to subscribe to the experiment data, download the experiment data, and perform analysis using the data (406). At some point, the teacher may close experiment data collection on the computer system (408) which shuts off access to any collected experiment data by the handheld computing devices and also terminates receiving experiment data from the data source.

The teacher may then optionally conduct further lecture/discussion regarding the experiment that may include performing and display analyses of the collected experiment data on the computer system. The teacher may also optionally configure the computer system to allow students to use the handheld computing devices to upload their analyses for further instructional purposes (410) such as grading, display and discussion, aggregation on the computer system, etc.

In the following paragraphs, two examples of network data collection in a classroom are presented. These examples are presented for illustrative purposes only and should not be construed as limiting the claimed invention. In a first example, a math classroom is configured with a classroom instruction system as described above in which the handheld computing devices are graphing calculators. The class is studying exponential functions, an example of which is cooling. To illustrate the concept of an exponential function, the teacher sets up an experiment in cooling using a temperature probe as the data source. The temperature probe is connected to a hub via a connection device that can collect data from the temperature probe and provide it to the hub for transmission. The teacher configures the computer system to receive experiment data from the hub and to allow the calculators used by the students to download the collected experiment data. The students perform hypothesis work on the calculators, and then wait for experiment data to be available. The teacher starts the generation of experiment data by placing the temperature probe in a hot cup of coffee.

Using the calculators, the students can subscribe to the experiment data on the computer system, down load the experiment data, and use the experiment data to generate graphs. The students will then be able to see that the curves they are seeing are not linear curves. The students can access the experiment data at different times so each calculator may show somewhat different results. Further, the teacher may set up access to the data such that each calculator can only access the experiment data for a predetermined time period (e.g., 30 seconds) during which other calculators cannot access the data, thus ensuring that each calculator receives a different set of the experiment data. Once the experiment is ended, the teacher may then configure the computer system to receive curves from the various calculators. These curves can then be integrated on the computer system to illustrate to the students a function over the entire set of experiment data.

In a second example, a physics classroom is configured with a classroom instruction system as described above in which the handheld computing devices are graphing calculators. The class is studying motion and acceleration, an example of which is the swinging of a pendulum. The teacher sets up an experiment using a motion sensing device such as the previously mentioned CBR 2™ as the data source and a pendulum. The motion sending device is connected to a hub for transmission of experiment data. The teacher configures the computer system to receive experiment data from the hub and to allow the calculators used by the students to download the collected experiment data. The students perform hypothesis work on the calculators, and then wait for experiment data to be available. The teacher starts the generation of experiment data by placing the pendulum in motion. Using the calculators, the students can subscribe to the experiment data on the computer system, down load the experiment data, and use the experiment data to perform analyses and generate graphs. The analyses performed by the students may also be transferred back to the computer system for further analysis and display.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims. It is therefore contemplated that the appended claims will cover any such modifications of the embodiments as fall within the true scope and spirit of the invention.

What is claimed is:

1. A method for experiment data collection in an instructional setting, the method comprising:
receiving over a network in the instructional setting experiment data from a data source generating the experiment data; and
providing over the network a first portion of the received experiment data to a first calculator.

2. The method of claim 1, further comprising receiving over the network a first analysis result from the first calculator, wherein the first analysis result is generated using the first portion of the received experiment data.

3. The method of claim 2, further comprising:
providing over the network a second portion of the received experiment data to a second calculator;
receiving over the network a second analysis result from the second calculator, wherein the second analysis result is generated using the second portion of the received experiment data; and
integrating the first analysis result and the second analysis result.

4. The method of claim 1, wherein the providing is performed for a predetermined period of time.

5. The method of claim 1, wherein the data source is at least one selected from a group consisting of a temperature sensor, a force sensor, a sound sensor, a humidity sensor, a light sensor, a motion sensor, a voltage sensor, a conductivity sensor, a flow rate sensor, a soil moisture sensor, a gas pressure sensor, a magnetic field sensor, a turbidity sensor, a salinity sensor, and a pH sensor.

6. The method of claim 1, wherein the data source is operatively connected to a first hub in the network and the first calculator is operatively connected to a second hub in the network, and wherein the receiving over the network further comprising receiving the experiment data from the first hub via an access point and the providing over the network further comprising providing the first portion of the experiment data via the access point to the second hub.

7. A classroom instruction system comprising:
a computer system comprising instructional software;
a data source communicatively coupled to the computer system via a network; and
a plurality of calculators communicatively coupled to the computer system via the network,
wherein the data source is configured to transmit experiment data over the network, the instructional software is configured to receive the experiment data and to provide portions of the experiment data to the plurality of calculators over the network, and the plurality of calculators are configured to subscribe to the received experiment data and to download at least one of the portions of the experiment data.

8. The classroom instruction system of claim 7, wherein each calculator of the plurality of calculators is further configured to perform an analysis of a received portion of the experiment data to generate an analysis result and to provide the analysis result to the instructional software.

9. The classroom instruction system of claim 7, further comprising:
a first hub configured to communicatively couple the data source to the network;
a second hub configured to communicatively couple the plurality of calculators to the network; and
an access point communicatively coupled to the computer system and configured to receive the experiment data from the first hub and to send the portions of experiment data to the second hub.

10. The classroom instruction system of claim 7, wherein the data source is at least one selected from a group consisting of a temperature sensor, a force sensor, a sound sensor, a humidity sensor, a light sensor, a motion sensor, a voltage sensor, a conductivity sensor, a flow rate sensor, a soil moisture sensor, a gas pressure sensor, a magnetic field sensor, a turbidity sensor, a salinity sensor, and a pH sensor.

11. The classroom instruction system of claim 7, wherein the instructional software is further configured to provide the portions of the experiment data to the plurality of calculators for predetermined time periods.

12. A method of instruction of students in an instructional setting, the method comprising:
communicatively coupling a data source configured to generate experiment data to a computer system;
communicatively coupling a plurality of calculators to the computer system;
conducting an experiment using the data source, wherein experiment data is transmitted to the computer system from the data source;
receiving the experiment data by the computer system; and
sending portions of the experiment data to the plurality of calculators responsive to requests from the plurality of calculators, wherein students use the calculators to analyze the portions of the experiment data to generate analysis results.

13. The method of claim 12, further comprising configuring instructional software on the computer system to provide the portions of experimental data for predetermined time periods.

14. The method of claim 12, further comprising configuring instructional software on the computer system to receive the analysis results from the calculators.

15. The method of claim 12, wherein sending portions of the experiment data further comprises sending a portion of the experiment data to a calculator of the plurality of calculators for a predetermined period of time.
